(19) United States
(12) Patent Application Publication
(10) Pub. No.: US 2011/0090243 A1
(43) Pub. Date: Apr. 21, 2011

(54) Apparatus and method for inter-view crosstalk reduction

(75) Inventors: Ju Yong Park, Seoul (KR); Yun-Tae Kim, Hwaseong-si (KR); Gee Young Sung, Daegu-si (KR); Dong Kyung Nam, Yongin-si (KR)

(73) Assignee: SAMSUNG ELECTRONICS CO., LTD., Suwon-si (KR)

(21) Appl. No.: 12/662,893

(22) Filed: May 10, 2010

(30) Foreign Application Priority Data
Oct. 16, 2009 (KR) 10-2009-0098734

(51) Int. Cl. G09G 5/00

(52) U.S. Cl. 345/617

(57) ABSTRACT

Disclosed is an inter-view crosstalk reduction apparatus and method. The inter-view crosstalk reduction apparatus applies a different margin value based on a spatial location of an image, the margin value being used to compensate for crosstalk, performs smoothing of a margin image, and applies a margin only to a portion where the margin is utilized, thereby decreasing crosstalk.

### CROSS-REFERENCE TO RELATED APPLICATION

This application claims the benefit of Korean Patent Application No. 10-2009-0098734, filed on Oct. 16, 2009, in the Korean Intellectual Property Office, the disclosure of which is incorporated herein by reference.

### BACKGROUND

1. Field

The example embodiments relate to an inter-view (view overlap) crosstalk reduction apparatus and method, and more particularly, to a technology that sets margin values to be different from each other, the margin values being used to compensate for crosstalk based on a spatial location in an image, and that decreases a contrast loss.

2. Description of the Related Art

When different images are separately displayed on a display device, interference between the images occurs. That is, undesired crosstalk between the images occurs in the display device, and thus, image quality is deteriorated and the viewer experiences fatigue when viewing a three-dimensional (3D) image.

A conventional method replaces a signal of black that has a minimum value of an existing signal with a same amount of grey signal as an amount of possible crosstalk generation, decreases a total dynamic range, and decreases the signal by the same amount as an amount of the possible crosstalk generation, thereby enabling a desired image to be represented when interference occurs. However, when luminance increases, the method may cause a decrease of a contrast ratio, and a chroma may also decrease.

### SUMMARY

Accordingly, it is an aspect to provide an apparatus and method for inter-view crosstalk reduction that decreases a loss of contrast ratio in the display device representing different images.

Additional aspects and/or advantages will be set forth in part in the description which follows and, in part, will be apparent from the description, or may be learned by practice of the embodiments.

The foregoing and/or other aspects are achieved by providing a crosstalk reduction apparatus, including an image input unit to receive a multi-view image including a plurality of view images, and a crosstalk eliminating unit to eliminate crosstalk by using a margin image having a different margin value for each location of the multi-view image.

The crosstalk eliminating unit may include a temporary image generating unit to calculate an effect that each multi-view image has on adjacent images, and to generate a temporary image, and an input image generating unit to apply the margin image to the temporary image, and to generate an input image.

The temporary image generating unit may include a crosstalk generation computing unit to compute an amount of generated crosstalk by performing a crosstalk calculation with respect to at least one adjacent image that has an effect on a first view image in the multi-view image, and generates the temporary image by using the amount of generated crosstalk.

Also, the input image generating unit includes a margin image generating unit to generate the margin image used to correct the temporary image and an image correcting unit to add the margin image to the temporary image to generate the input image.

Also, the margin image generating unit may include a pixel extracting unit to extract at least one pixel having a negative number, when the at least one pixel of the temporary image is the negative number, a minimum value selecting unit to select a minimum value of the extracted at least one pixel for each unit area, and a point image generating unit to generate the margin image by replacing a value of the extracted at least one pixel of each unit area with an absolute value of the minimum value selected for each unit area.

Also, the margin image generating unit includes a smoothing unit to smooth the margin image, and the image correcting unit adds the smoothed image to the temporary image.

The foregoing and/or other aspects are achieved by providing a crosstalk reduction method, including receiving a multi-view image including a plurality of view images, and eliminating crosstalk including using a margin image having a difference margin value for each location of the multi-view image.

In this instance, the eliminating of the crosstalk includes generating a temporary image by calculating an effect that each of the multi-view images has on adjacent images, and generating an input image by applying the margin image to the temporary image.

Also, the generating of the input image includes generating the margin image used to correct the temporary image, and generating the input image by adding the margin image to the temporary image.

Also, the generating of the margin image includes extracting at least one pixel having a negative number when the at least one pixel of the temporary image is the negative number, selecting a minimum value of the extracted at least one pixel for each unit area, and generating the margin image by replacing a value of the extracted at least one pixel of each unit area with an absolute value of the minimum value selected for each unit area.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an example configuration of an inter-view crosstalk reduction apparatus according to an embodiment;

FIG. 2 illustrates an example process of generating a temporary image according to an embodiment;

FIG. 3 illustrates an example configuration of an input image generating unit in the inter-view crosstalk reduction apparatus of FIG. 1;

FIG. 4 is a flowchart illustrating an example inter-view crosstalk reduction method according to an embodiment;

FIG. 5 is a diagram illustrating an example process of eliminating crosstalk in the inter-view crosstalk reduction method of FIG. 4;

FIG. 6 is a diagram illustrating an example process of generating a temporary image in the process of eliminating crosstalk of FIG. 5;

FIG. 7 is a diagram illustrating an example process of generating an input image in the process of eliminating crosstalk of FIG. 5; and

FIG. 8 is a diagram illustrating an example process of generating a margin image in the process of generating an input image of FIG. 7.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

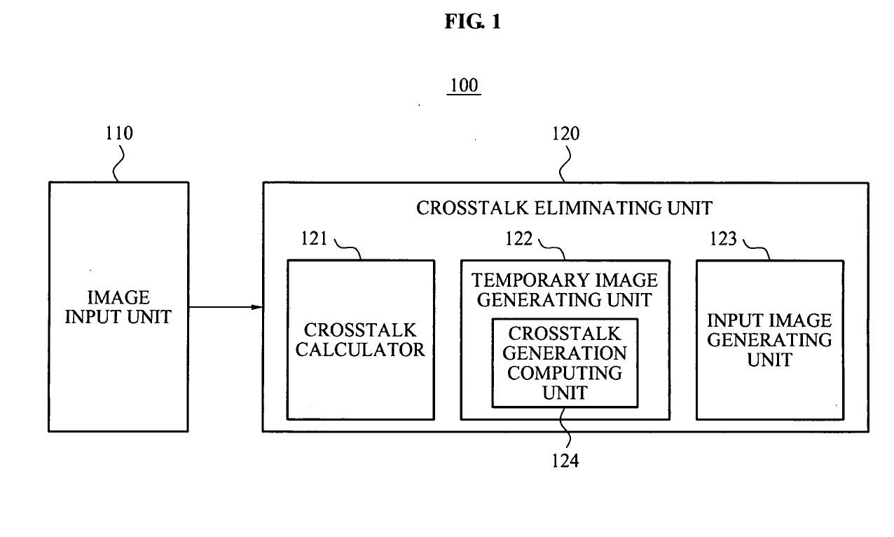

FIG. 1 illustrates a configuration of an inter-view crosstalk reduction apparatus according to example embodiments.

Referring to FIG. 1, the inter-view crosstalk reduction apparatus 100 may include an image input unit 110 and a crosstalk eliminating unit 120.

The image input unit 110 may receive a multi-view image. In this instance, the multi-view image may be an image of a glass-type/auto stereo display device, a multi-view 3D display device, a directional 3D display device, and the like. Also, the multi-view image may also be applicable to a device that simultaneously represents different images which are not 3D images, and an area of utilizing the multi-view image may include a general domain of utilizing a 3D display, such as a home TV, a monitor, a display of a portable device, a display for advertisement, a display for education, and the like, and a domain of utilizing a multi-view display that displays different images using a single device.

The crosstalk eliminating unit 120 may eliminate crosstalk by using a margin image having a different value for each location of the multi-view image. Here, the crosstalk eliminating unit 120 may include a crosstalk calculator 121, a temporary image generating unit 122 and an input image generating unit 123.

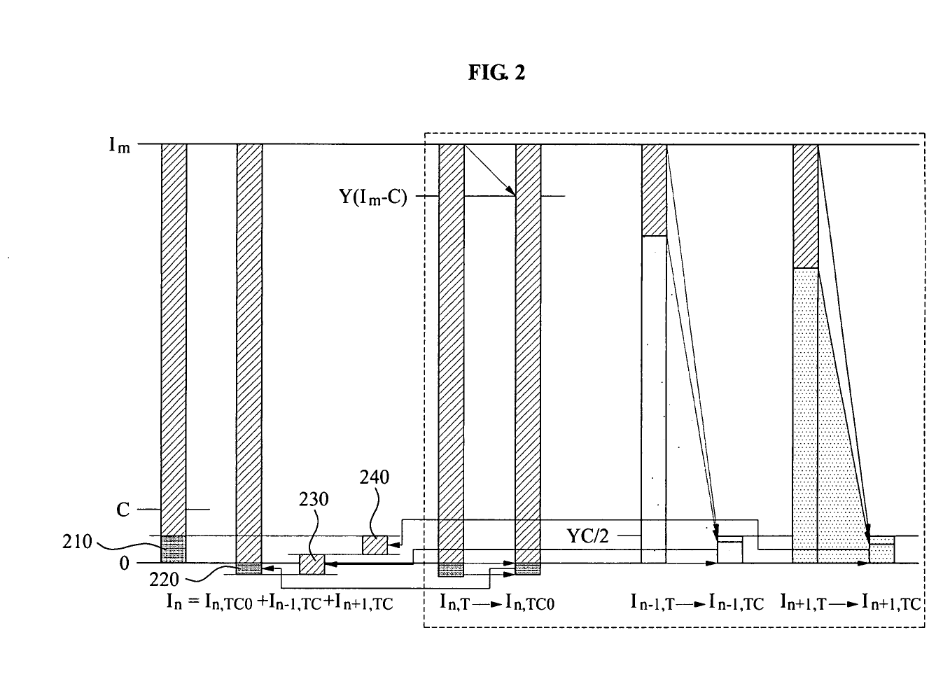

The temporary image generating unit 122 may calculate an effect that each of the multi-view images has on adjacent images, and generates a temporary image. In this instance, the temporary image generating unit 122 may include a crosstalk generation computing unit 124 to compute an amount of generated crosstalk by performing a crosstalk calculation with respect to at least one adjacent image that has an effect on a first view image of the multi-view image, and may generate the temporary image by using the amount of generated crosstalk. That is, a degree of having an effect on an arbitrary viewpoint image is calculated for each adjacent image having an effect on the arbitrary viewpoint image, and a temporary image may be generated based on a result of the calculation. Here, the process of generating the temporary image will be further described with reference to FIG. 2.

FIG. 2 illustrates an example process of generating a temporary image according to an embodiment.

Referring to FIG. 2, a crosstalk calculation may be performed with respect to an n−1^{th} image, an n^{th} image, and an n+1^{th} image that have an effect on the n^{th} image, to reproduce the n^{th} image (Iₙ) 210 where crosstalk is eliminated. In this instance, during the performing of the crosstalk calculation, images to be inputted to the display device are defined as I_{(n,T)}, I_{(n-1,T)}, I_{(n+1,T)}, and an effect that each of the images has on the n^{th} image may be calculated when crosstalk occurs.

In this instance, the I_{(n,T)} image has a same amount of effect as C/Iₘ in two directions, and a remaining amount of effect contributes to a luminance of the I_{(n,T)} image. Accordingly, the remaining amount of effect may be I_{(n,TC0)} that is an amount of scaling from a [0, Iₘ] section to a [0, Iₘ−C] section. Here, C is a margin for eliminating crosstalk, and indicates a size of crosstalk occurring when a value of an adjacent image is a signal maximal value Iₘ. In this instance, I_{(n,T)} may be scaled to a [0, γ(Iₘ−C)] section, as opposed to a [0, Iₘ−C] section. In this instance, γ is a value included in [0,1] section, and γ is a coefficient to prevent a case that an I_{(n,T)} value is greater than Iₘ, when γ=1. As an example, for a case that demands Iₙ=Iₘ, I_{(n-1,T)}=0, and I_{(n+1,T)}=0, is a situation where an I_{(n,T)} value is to be greater than Iₘ. Accordingly, a relationship between I_{(n,T)} and I_{(n,TC0)} may be represented as given in Equation 1.

I_{(n,TC0)}=I_{(n,T)}*γ(ₘ−C)/Iₘ [Equation 1]

In this instance, an I_{(n,TC0)} value 220 may preferentially compute an I_{(n-1,TC)} value 230 and an I_{(n+1,TC)} value 240, and may calculate the I_{(n,TC0)} value 220 that fulfills Iₙ=I_{(n,TC0)}+I_{(n-1,TC)}+I_{(n+1,TC)}.

Also, an I_{(n-1,T)} image and an I_{(n+1,T)} image appear to be crosstalk with respect to I_{(n,T)} and thus, have a same amount of effect as an I_{(n-1,TC)} value 230 and an I_{(n+1,TC)} value 240 which are scaled from a [0, Iₘ] section to a [0,C/2] section, on the I_{(n,T)}. In this instance, the section scaling may be performed the I_{(n-1,TC)} value 230 and the I_{(n+1,TC)} value 240 are scaled to [0,γC/2], as opposed to [0,C/2], and this is based on the same reason of the I_{(n,T)} value. Equations for calculating the I_{(n-1,TC)} value 230 and the I_{(n+1,TC)} value 240 may be represented as given in Equation 2 and Equation 3, respectively.

I_{(n-1,TC)}=I_{(n-1,T)}*γC/(2* Iₘ) [Equation 2]

I_{(n+1,TC)}=I_{(n+1,TC)}*γC/(2*Iₘ) [Equation 3]

Accordingly, when sum of the I_{(n,TC0)} value 220, the I_{(n-1,TC)} value 230, and the I_{(n+1,TC)} value 240 which are scaled values of the I_{(n,T)} value, the I_{(n-1,T)} value, and I_{(n+1,T)} is determined to be identical to the Iₙ 210 of an n^{th} image, and the I_{(n,T)} value, the I_{(n-1,T)} value, and the I_{(n+1,T)} value are input values of a display device, Iₙ that does not have crosstalk may be provided. Here, although all the I_{(n,T)} value, the I_{(n-1,T)} value, and the I_{(n+1,T)} value to be the input values of the display device are to be included in [0, Iₘ], the I_{(n,T)} value may be determined to be a negative value, when the Iₙ value is excessively small. However, the I_{(n,T)} value cannot be a negative value, since the I_{(n,T)} value is a value to be represented as an actual image. Accordingly, there is need of a crosstalk margin for correcting all the I_{(n,T)} value, the I_{(n-1,T)} value, and the I_{(n+1,T)} value to be positive values to prevent values which are to be represented as the actual image from being determined as negative values. That is, the I_{(n,T)} value, the I_{(n-1,T)} value, and the I_{(n+1,T)} value may not be used as is, as the input values of the display device, and thus, may be stored as a temporary image.

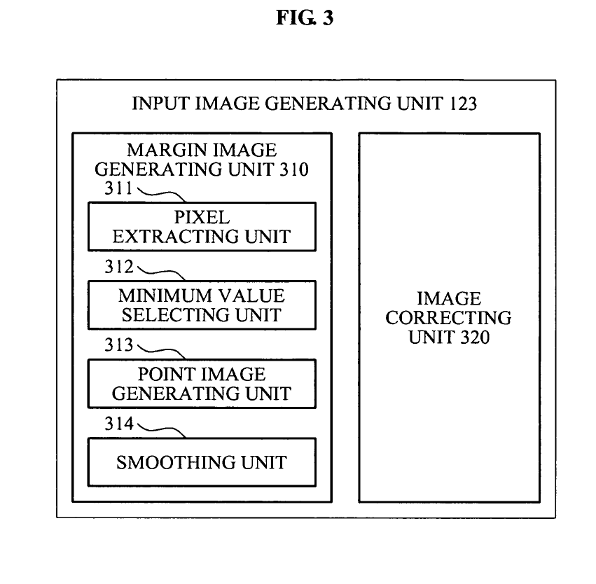

Referring again to FIG. 1, the input image generating unit 123 may generate an input image by applying the margin image to the temporary image. That is, as described above, the temporary image may not be used as is, as an input value of the display device, and thus, the temporary image is corrected by applying the margin image. Here, the input image generating unit 123 will be further described with reference to FIG. 3.

FIG. 3 illustrates an example configuration of an input image generating unit in the inter-view crosstalk reduction apparatus of FIG. 1.

The input image generating unit 123 may include a margin image generating unit 310 and an image correcting unit 320. To obtain a crosstalk margin to correct all of the I_{(n,T)}, I_{(n-1,T)}, and I_{(n+1,T)} values to be negative values, a portion having a negative value is extracted from the I_{(n,T)} value, and the temporary image may be corrected by using a margin image that is represented with an image having the same amount of positive value as the extracted portion having the negative value.

Accordingly, the margin image generating unit 310 may generate the margin image to correct the temporary image, and may include a pixel extracting unit 311, a minimum value selecting unit 312, a point image generating unit 313, and a smoothing unit 314.

The pixel extracting unit 311 may extract at least one pixel having a negative value, when the at least one pixel value of the temporary image has the negative value. Here, the image from which only the pixel having the negative value is extracted is used to obtain a smooth image by performing a smoothing process, and thus, a high resolution may not be needed. Accordingly, a burden of calculating may decrease since an image with a lower resolution, compared with an original image, is obtained.

The minimum value selecting unit 312 may select a minimum value of an extracted pixel for each unit area, and the point image generating unit 313 may generate the margin image by replacing a value of the extracted pixel for each unit area with an absolute value of the minimum value selected for each unit area. As an example, when a width resolution and a height resolution are 1/b of the original image, a minimum value of a pixel is selected, the pixel being extracted with respect to a unit block in a size of b*b in the image from which the pixel having the negative value is extracted, and the extracted pixel or the unit block is replaced with an absolute value of the selected minimum value, and thus, the margin image is constructed. That is, although a point has a negative value in the block in the size of b*b, the margin image may be constructed based on the negative value. Here, the image from which the pixel having the negative value is only extracted may be a point image that is represented by a distribution of discontinuous points.

The smoothing unit 314 may perform smoothing of the margin image, and thus, a pattern of the crosstalk margin is not prominent in an output image. Here, a low pass filter may be used in the smoothing process. Accordingly, a smooth image that makes a shape of the crosstalk margin to not be prominent is obtained by using a filter having an appropriate size and an appropriate value. As an example, values adjacent to a given pixel are adjusted to make the given pixel to not be prominent in the point image that is represented as the distribution of discontinuous points, thus, the point image becomes a smooth image.

The image correcting unit 320 may generate an input image by adding the smoothed image to the temporary image. In this instance, when values are simply added, a result value may be greater than Iₘ, and thus, a scaling process may be performed again. Accordingly, a smooth output image where a crosstalk margin is not prominent and a crosstalk is eliminated is obtained through the generated input image.

Referring again to FIG. 1, although not illustrated, the crosstalk eliminating unit 120 may include a crosstalk information extracting unit. The crosstalk information extracting unit may extract, by a sensor, crosstalk information including at least one of a crosstalk generation ratio and an amount of generated crosstalk.

As described above, there is provided a crosstalk reduction apparatus that may obtain a required amount of margin needed to obtain the crosstalk margin and may perform a smoothing process of the margin image to prevent generation of an artifact in an image, and thereby may minimize a contrast ratio and may output a smooth image.

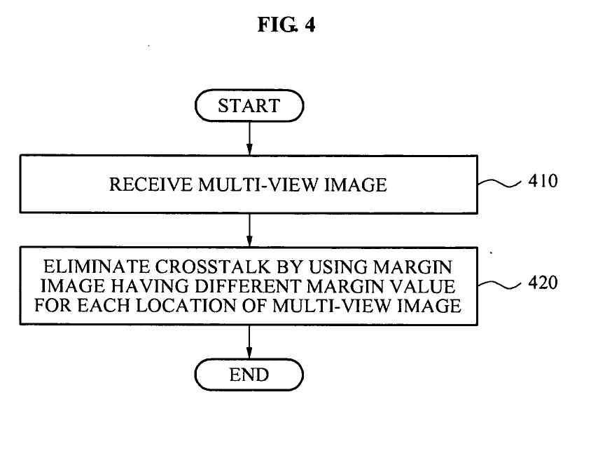

FIG. 4 is a flowchart illustrating an example inter-view crosstalk reduction method according to an embodiment.

Referring to FIG. 4, a multi-view image is received in operation 410.

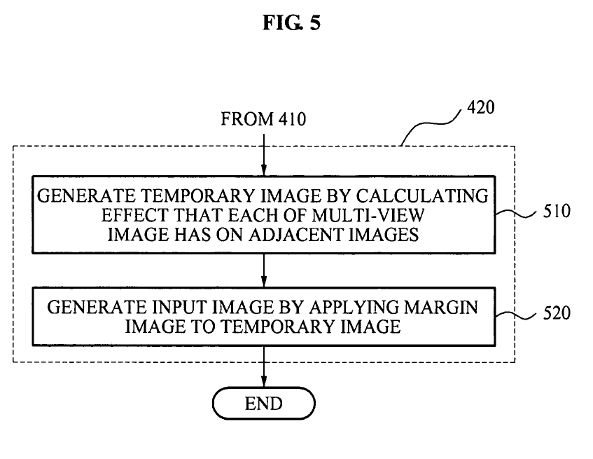

In operation 420, crosstalk is eliminated by using a margin image having a different margin value for each location of the multi-view image. Here, while a margin is obtained to eliminate the crosstalk, a loss of a contrast ratio may occur when the same margin is applied to the entire image without considering a feature of the image, and thus, different margins may be applied for each location of the image. Here, operation 420 will be further described with reference to FIG. 5.

FIG. 5 is a diagram illustrating an example process of eliminating crosstalk in the inter-view crosstalk reduction method of FIG. 4.

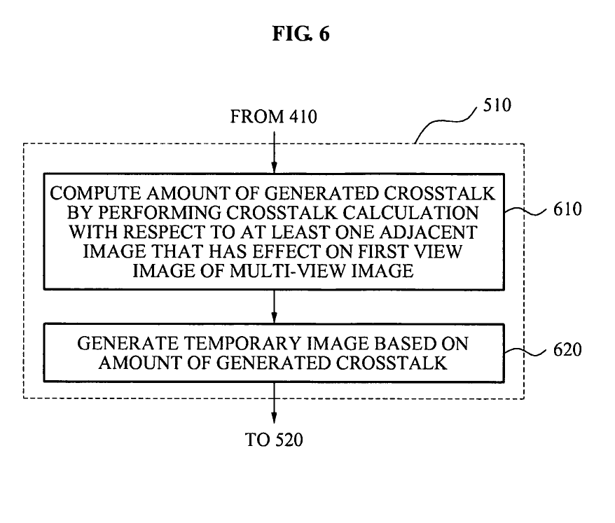

Referring to FIG. 5, a temporary image may be generated by calculating an effect that each of the multi-view images has on adjacent images in operation 510. That is, an effect that an adjacent view image has on an arbitrary view image is calculated in advance to adjust an image to be inputted, and thus, an image having a reduced crosstalk may be displayed. Here, operation 510 will be further described with reference to FIG. 6.

FIG. 6 is a diagram illustrating an example process of generating the temporary image in the process of eliminating crosstalk of FIG. 5.

Referring to FIG. 6, an amount of generated crosstalk is computed by performing a crosstalk calculation with respect to at least one adjacent image that has an effect on a first view image of a multi-view image in operation 610. That is, a degree of having an effect on a generation of crosstalk is calculated with respect to the adjacent view images that have an effect on the generation of the crosstalk of an arbitrary view image.

In operation 620, the temporary image may be generated based on the amount of the generated crosstalk. That is, an image having been calculated to output an effect that the adjacent view images have on the image in advance, may prevent the crosstalk from being generated.

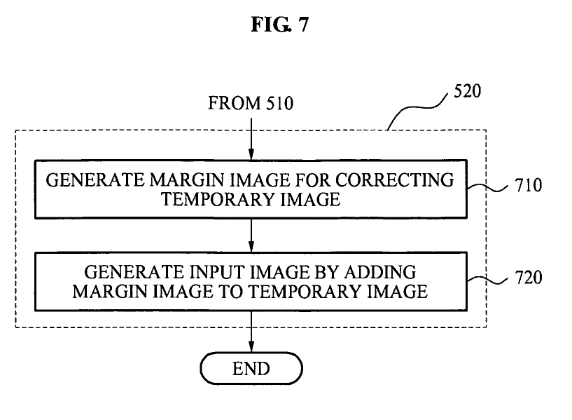

Referring again to FIG. 5, an input image may be generated by applying a margin image to the temporary image in operation 520. Below, operation 520 will be further described with reference to FIG. 7.

FIG. 7 is a diagram illustrating an example process of generating an input image in the process of eliminating crosstalk of FIG. 5.

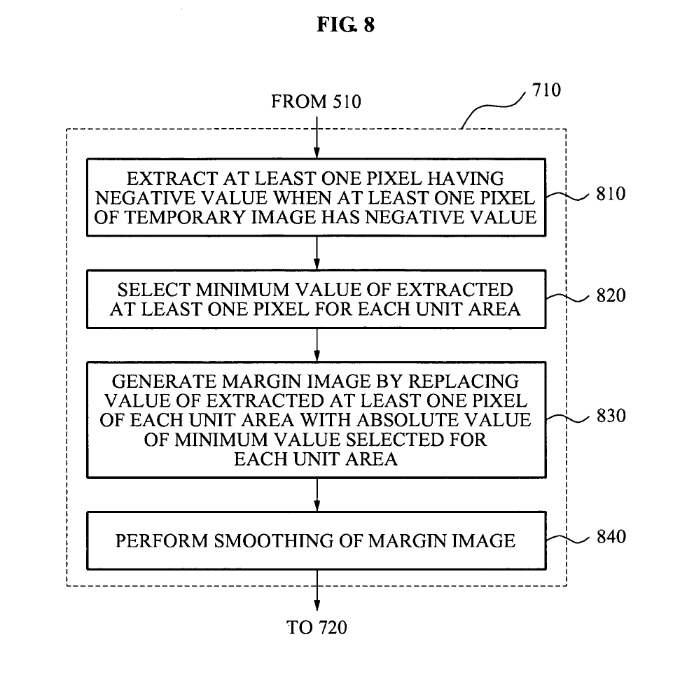

Referring to FIG. 7, the margin image may be generated for correcting the temporary image in operation 710. The margin image is an image prepared for correcting the temporary image, in case the temporary image that is supposed to represent a positive value is determined to be a negative value. Here, operation 710 will be further described with reference to FIG. 8.

FIG. 8 is a diagram illustrating an example process of generating a margin image in the process of generating an input image of FIG. 7.

Referring to FIG. 8, when at least one pixel of the temporary image has a negative value, the at least one pixel having the negative value is extracted in operation 810.

In operation 820, a minimum value of the extracted pixel for each unit area is selected.

In operation 830, the margin image is generated by replacing a value of the extracted pixel for each unit area with an absolute value of the minimum value selected for each unit area. Accordingly, an input image is corrected so as to not have a negative value by using the margin image, the input image being determined as a positive value.

In operation 840, the margin image is smoothed.

Referring again to FIG. 7, the input image is generated by adding the margin image to the temporary image in operation 720. In this instance, the margin image is added to the temporary image, and further, a scaling process is performed, thus, a result value is not greater than Iₘ.

Also, omitted description about FIGS. 4 through 7 may be understood by descriptions of FIGS. 1 through 3.

As described above, there is provided a crosstalk reduction apparatus and method that applies a different margin value to correct crosstalk, based on a spatial location of a temporary image, decreases crosstalk of a portion where a margin is to be applied, and obtains a contrast ratio of an original image with respect to a portion where the margin is not applied, thereby decreasing a loss of the contrast ratio.

Also, a margin image that is represented as discontinuous points is smoothed, thereby providing a smooth result image after performing a crosstalk reduction process.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Although a few example embodiments have been shown and described, it would be appreciated by those skilled in the art that changes may be made in these example embodiments without departing from the principles and spirit of the embodiments, the scope of which is defined in the claims and their equivalents.

What is claimed is:

1. A crosstalk reduction apparatus, comprising:
an image input unit to receive a multi-view image comprising a plurality of view images; and
a crosstalk eliminating unit to eliminate crosstalk by using a margin image having a different margin value for each location of the multi-view image.

2. The crosstalk reduction apparatus of claim 1, wherein the crosstalk eliminating unit comprises:
a temporary image generating unit to calculate an effect that each of the view images has on adjacent images, and to generate a temporary image; and
an input image generating unit to apply the margin image to the temporary image, and to generate an input image.

3. The crosstalk reduction apparatus of claim 2, wherein the temporary image generating unit comprises a crosstalk generation computing unit to compute an amount of generated crosstalk by performing a crosstalk calculation with respect to at least one of the adjacent images that has an effect on a first view image of the multi-view image, and generates the temporary image by using the amount of generated crosstalk.

4. The crosstalk reduction apparatus of claim 2, wherein the input image generating unit comprises:
a margin image generating unit to generate the margin image used to correct the temporary image; and
an image correcting unit to add the margin image to the temporary image to generate the input image.

5. The crosstalk reduction apparatus of claim 4, wherein the margin image generating unit comprises:
a pixel extracting unit to extract at least one pixel having a negative number, wherein at least one pixel of the temporary image is a negative number;
a minimum value selecting unit to select a minimum value of the extracted at least one pixel for each unit area; and
a point image generating unit to generate the margin image by replacing a value of the extracted at least one pixel of each unit area with an absolute value of the minimum value selected for each unit area.

6. The crosstalk reduction apparatus of claim 4, wherein:
the margin image generating unit comprises a smoothing unit to smooth the margin image; and
the image correcting unit adds the smoothed image to the temporary image.

7. The crosstalk reduction apparatus of claim 6, further comprising a low pass filter, wherein the smoothing unit performs a smoothing process by using the low pass filter.

8. The crosstalk reduction apparatus of claim 1, wherein the crosstalk eliminating unit comprises a crosstalk information extracting unit comprising a sensor to extract crosstalk information including at least one of a crosstalk generation ratio and an amount of generated crosstalk.

9. The crosstalk reduction apparatus of claim 2, wherein the temporary image generating unit comprises a crosstalk calculator to perform a crosstalk calculation by scaling a pixel value of each of the view images, and generates the temporary image by using the scaled pixel value.

10. The crosstalk reduction apparatus of claim 9, wherein the crosstalk calculator performs scaling of the pixel value by using a gamma value between zero and 1.

11. A crosstalk reduction method, comprising:
receiving a multi-view image comprising a plurality of view images; and
eliminating crosstalk comprising using a margin image having a difference margin value for each location of the multi-view image.

12. The crosstalk reduction method of claim 11, wherein the eliminating of the crosstalk comprises:
generating a temporary image comprising calculating an effect that each of the view images has on adjacent images; and
generating an input image comprising applying the margin image to the temporary image.

13. The crosstalk reduction method of claim 12, wherein the generating of the temporary image comprises:
computing an amount of generated crosstalk comprising performing a crosstalk calculation with respect to at least one adjacent image that has an effect on a first view image of the multi-view image; and
generating the temporary image comprising using the amount of generated crosstalk.

14. The crosstalk reduction method of claim 12, wherein the generating of the input image comprises:
generating the margin image used to correct the temporary image; and
generating the input image comprising adding the margin image to the temporary image.

15. The crosstalk reduction method of claim 14, wherein the generating of the margin image comprises:
extracting at least one pixel having a negative number, wherein at least one pixel of the temporary image is the negative number;
selecting a minimum value of the extracted at least one pixel for each unit area; and
generating the margin image comprising replacing a value of the extracted at least one pixel of each unit area with an absolute value of the minimum value selected for each unit area.

16. The crosstalk reduction method of claim 14, wherein:
the generating of the margin image further comprises smoothing the margin image; and
the generating of the input image comprises adding the smoothed image to the temporary image.

17. The crosstalk reduction method of claim 16, wherein the smoothing comprises using a low pass filter.

18. The crosstalk reduction method of claim 11, wherein the eliminating of the crosstalk comprises extracting, by using a sensor, crosstalk information including at least one of a crosstalk generation ratio and an amount of generated crosstalk.

19. The crosstalk reduction method of claim 12, wherein the generating of the temporary image comprises:
performing a crosstalk calculation comprising scaling a pixel value of each of the view images; and
generating the temporary image comprising using the scaled pixel value.

20. The crosstalk reduction method of claim 19, wherein the performing of the crosstalk calculation comprises performing scaling of the pixel value comprising using a gamma value that is between from zero and 1.

21. A computer readable recording media storing a program implementing the method of claim 11.
